(19) United States
(12) Patent Application Publication
(10) Pub. No.: US 2018/0084487 A1
(43) Pub. Date: Mar. 22, 2018

(54) RADIO ACCESS OUT OF SERVICE RECOVERY

(71) Applicant: QUALCOMM Incorporated, San Diego, CA (US)

(72) Inventors: Bhaskaran Arumugam, Hyderabad (IN); Manjunatha Subbamma Ananda, Hyderabad (IN); Santhana Palanisamy, Hyderabad (IN); Sai Lokesh Ladhagiri Krishnakumar, Hyderabad (IN)

(21) Appl. No.: 15/270,560

(22) Filed: Sep. 20, 2016

(51) Int. Cl. H04W 48/16; H04W 48/00

(52) U.S. Cl. CPC H04W 48/16; H04W 48/17

(57) ABSTRACT

Methods, systems, and devices for wireless communication are described. A user equipment (UE) may search for a first network associated with a first radio access technology (RAT) during a first time period in a RAT search cycle. The UE may search, when service is not acquired, for a second network associated with a second RAT during a second time period in the RAT search cycle. The UE may identify a radio frequency (RF) spectrum overlap in which a first RF band associated with the first RAT overlaps with a second RF band associated with the second RAT. When service is not acquired with respect to the second RAT, the UE may scan for RF energy corresponding to the second RF band of the second RAT. Then, the UE may determine whether to perform a subsequent search for the first network in the first RF band of the first RAT.

### TECHNICAL FIELD

The following relates generally to wireless communication, and more specifically to providing radio access out of service recovery.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

A base station may provide service to a UE. However, there are times when service may be temporarily lost between a base station and a UE. When service is lost by a UE on an LTE network, for example, a full search on all supported LTE radio frequency (RF) bands is generally triggered. If the full LTE search results in no service being acquired with respect to an LTE network, a search on other supported radio access technologies (RATs) for the last camped or registered public land mobile network (RPLMN) may be initiated to recover from the loss of service. However, improved methods of recovering from an out of service condition are desired.

### SUMMARY

The described techniques relate to improved methods, systems, devices, or apparatuses that support providing radio access out of service recovery. Generally, the described techniques provide for a user equipment (UE) to quickly recover from an out of service condition and efficiently obtain, for example, a preferred network such as a Long Term Evolution (LTE) network or system. In some aspects, the UE may search for a first network associated with a first radio access technology (RAT) during a first time period in a RAT search cycle after losing service on the first network. The UE may identify a radio frequency (RF) spectrum overlap in which a first RF band associated with the first RAT overlaps with a second RF band associated with the second RAT. When service is not acquired with respect to the second RAT, the UE may scan for RF energy corresponding to the second RF band of the second RAT. The UE may then determine, based at least in part on the scan for RF energy, whether to perform a subsequent search for the first network in the first RF band of the first RAT. Thus, the UE may interrupt a search order of the RAT search cycle to attempt to acquire service from the first network after having recently just searched the first network. This approach where an RF spectrum overlap may be identified and RF energy may be scanned based at least in part on that RF spectrum overlap may improve out of service recovery time, particularly when the first network is only temporarily out of service or briefly unavailable.

A method of wireless communication is described. The method may include searching for a first network associated with a first RAT during a first time period in a RAT search cycle, searching, when service is not acquired with respect to the first RAT, for a second network associated with a second RAT during a second time period in the RAT search cycle, identifying an RF spectrum overlap in which a first RF band associated with the first RAT overlaps with a second RF band associated with the second RAT, scanning, when service is not acquired with respect to the second RAT, for RF energy corresponding to the second RF band of the second RAT, and determining, based at least in part on the scanning, whether to perform a subsequent search for the first network in the first RF band of the first RAT.

An apparatus for wireless communication is described. The apparatus may include means for searching for a first network associated with a first RAT during a first time period in a RAT search cycle, means for searching, when service is not acquired with respect to the first RAT, for a second network associated with a second RAT during a second time period in the RAT search cycle, means for identifying an RF spectrum overlap in which a first RF band associated with the first RAT overlaps with a second RF band associated with the second RAT, means for scanning, when service is not acquired with respect to the second RAT, for RF energy corresponding to the second RF band of the second RAT, and means for determining, based at least in part on the scanning, whether to perform a subsequent search for the first network in the first RF band of the first RAT.

Another apparatus for wireless communication is described. The apparatus may include a processor, memory in electronic communication with the processor, and one or more instructions stored in the memory. The one or more instructions may be operable to cause the processor to search for a first network associated with a first RAT during a first time period in a RAT search cycle, search, when service is not acquired with respect to the first RAT, for a second network associated with a second RAT during a second time period in the RAT search cycle, identify an RF spectrum overlap in which a first RF band associated with the first RAT overlaps with a second RF band associated with the second RAT, scan, when service is not acquired with respect to the second RAT, for RF energy corresponding to the second RF band of the second RAT, and determine, based at least in part on the scanning, whether to perform a subsequent search for the first network in the first RF band of the first RAT.

A non-transitory computer readable medium for wireless communication is described. The non-transitory computer-readable medium may include one or more instructions operable to cause a processor to search for a first network associated with a first RAT during a first time period in a RAT search cycle, search, when service is not acquired with respect to the first RAT, for a second network associated with a second RAT during a second time period in the RAT search cycle, identify an RF spectrum overlap in which a first RF band associated with the first RAT overlaps with a second RF band associated with the second RAT, scan, when service is not acquired with respect to the second RAT, for RF energy corresponding to the second RF band of the second RAT, and determine, based at least in part on the scanning, whether to perform a subsequent search for the first network in the first RF band of the first RAT.

Some examples of the method, apparatus, and non-transitory computer-readable medium described above may further include processes, features, means, or instructions for performing the subsequent search for the first network when the RF energy satisfies a threshold for operable communications associated with the first RAT.

Some examples of the method, apparatus, and non-transitory computer-readable medium described above may further include processes, features, means, or instructions for setting, based at least in part on scanning for RF energy, a first RAT suspect indicator. Some examples of the method, apparatus, and non-transitory computer-readable medium described above may further include processes, features, means, or instructions for sending the first RAT suspect indicator to a non-access stratum layer entity.

Some examples of the method, apparatus, and non-transitory computer-readable medium described above may further include processes, features, means, or instructions for setting, based at least in part on scanning for RF energy, a RAT search continuity parameter to identify the second RAT for further searching of one or more additional RF bands associated with the second RAT if service may be not acquired with respect to the first RAT based at least in part on the subsequent search. Some examples of the method, apparatus, and non-transitory computer-readable medium described above may further include processes, features, means, or instructions for performing, based at least in part on the first RAT suspect indicator, the subsequent search for the first network.

Some examples of the method, apparatus, and non-transitory computer-readable medium described above may further include processes, features, means, or instructions for setting, based at least in part on scanning for RF energy, a RAT search continuity parameter to identify a third RAT for further searching if service may be not acquired with respect to the first RAT based at least in part on the subsequent search. Some examples of the method, apparatus, and non-transitory computer-readable medium described above may further include processes, features, means, or instructions for performing, based at least in part on the first RAT suspect indicator, the subsequent search for the first network.

Some examples of the method, apparatus, and non-transitory computer-readable medium described above may further include processes, features, means, or instructions for sending, when service may be not acquired with respect to the first RAT, first network camped history information to a non-access stratum entity. Some examples of the method, apparatus, and non-transitory computer-readable medium described above may further include processes, features, means, or instructions for determining, prior to identifying the RF spectrum overlap, that the first RF band associated with the first RAT may be included in the first network camped history information.

Some examples of the method, apparatus, and non-transitory computer-readable medium described above may further include processes, features, means, or instructions for setting, based at least in part on the identifying the RF spectrum overlap, an RF spectrum overlap indicator. Some examples of the method, apparatus, and non-transitory computer-readable medium described above may further include processes, features, means, or instructions for sending, based at least in part on the RF spectrum overlap, network information associated with the first RAT to a radio resource entity associated with the second RAT.

Some examples of the method, apparatus, and non-transitory computer-readable medium described above may further include processes, features, means, or instructions for sending network information associated with the first RAT comprises sending, by a non-access stratum layer entity, network information including the first RF band and at least one evolved universal terrestrial access (E-UTRAN) absolute radio frequency channel number (EARFCN) to the radio resource entity associated with the second RAT.

Some examples of the method, apparatus, and non-transitory computer-readable medium described above may further include processes, features, means, or instructions for mapping, by the radio resource entity associated with the second RAT, the network information associated with the first RAT to the second RF band and at least one universal terrestrial access (UTRA) absolute radio frequency channel number (UARFCN).

In some examples of the method, apparatus, and non-transitory computer-readable medium described above, the scanning for RF energy corresponding to the second RF band comprises scanning, based at least in part on the mapping, for RF energy corresponding to the second RF band of the second RAT.

In some examples of the method, apparatus, and non-transitory computer-readable medium described above, the RAT search cycle includes a sequential order of RATs to be searched that includes at least one of searching the first RAT during the first time period, searching the second RAT during the second time period, or searching a third RAT during a third time period.

In some examples of the method, apparatus, and non-transitory computer-readable medium described above, the second RAT may be different from the first RAT and the third RAT may be different from the first RAT and the second RAT.

In some examples of the method, apparatus, and non-transitory computer-readable medium described above, the subsequent search for the first network comprises an LTE acquisition database scan.

Some examples of the method, apparatus, and non-transitory computer-readable medium described above may further include processes, features, means, or instructions for acquiring service with respect to the first RAT based at least in part on the subsequent search, without searching for a third network associated with a third RAT during a third time period in the RAT search cycle.

### BRIEF DESCRIPTION OF THE DRAWINGS

FIG. 1 illustrates an example of a system for wireless communication that supports providing radio access out of service recovery in accordance with aspects of the present disclosure.

FIG. 2 illustrates an example of an out of service scenario in which radio access out of service recovery techniques are performed in accordance with aspects of the present disclosure.

FIG. 3 illustrates an example of a process flow that describes radio access out of service recovery techniques in accordance with aspects of the present disclosure.

FIG. 4 illustrates an example of a protocol-layer process flow that describes radio access out of service recovery techniques in accordance with aspects of the present disclosure.

FIGS. 5 through 7 show block diagrams of a device that supports providing radio access out of service recovery in accordance with aspects of the present disclosure.

FIG. 8 illustrates a block diagram of a system including a user equipment (UE) that supports providing radio access out of service recovery in accordance with aspects of the present disclosure.

FIGS. 9 through 13 illustrate methods for providing radio access out of service recovery in accordance with aspects of the present disclosure.

### DETAILED DESCRIPTION

When service to a user equipment (UE) is lost in a Long Term Evolution (LTE) network, a non-access stratum (NAS) process may trigger a service recovery search that begins with a search on all supported LTE radio frequency (RF) bands. If LTE service cannot be established, the service recovery search may continue to search for service with respect to other supported radio access technologies (RATs) associated with the previously camped or registered public land mobile networks (RPLMNs). During the service recovery search, each of the RATs may be searched for an RPLMN, and if service is found, further registration is performed with respect to the corresponding RAT and RPLMN. If a particular RAT does not achieve service, that particular RAT communicates at the radio resource control (RRC) protocol layer to the NAS protocol layer to continue searching on other RATs (e.g., the next successive RAT in an order that may be determined based on a mobile device configuration or designated by the user).

In certain service environments and network scenarios, it would be advantageous to employ further intelligence for recovering LTE service on a UE. For example, a plurality of RATs may be present in one region of a network (e.g., each of LTE, wideband code division multiple access (WCDMA), Global System for Mobile Communications (GSM), etc. available for providing service), whereas other regions may only include a subset of RATs (e.g., LTE only, LTE with WCDMA, or LTE with GSM). Thus, when a wireless device enters a region that only has LTE and WCDMA RATs, a radio frequency scan for GSM will yield no service results for those RPLMNs.

Techniques for efficiently recovering LTE service on a UE are described in which frequency bands associated with LTE are compared with frequency bands of one or more other RATs (e.g., WCDMA, GSM, etc.) to ascertain frequency overlap information. This frequency overlap information and detection of RF energy in such frequencies may then be used by the UE to improve the service recovery process.

Aspects of the disclosure are initially described in the context of a wireless communications system. A non-limiting example of an out of service scenario is then provided where the inventive process may improve the service recovery process. An example technique and protocol-layer process flow are also described to explain various inventive aspects of recovering from an out of service condition. Aspects of the disclosure are further illustrated by and described with reference to apparatus diagrams, system diagrams, and flowcharts that relate to providing radio access out of service recovery.

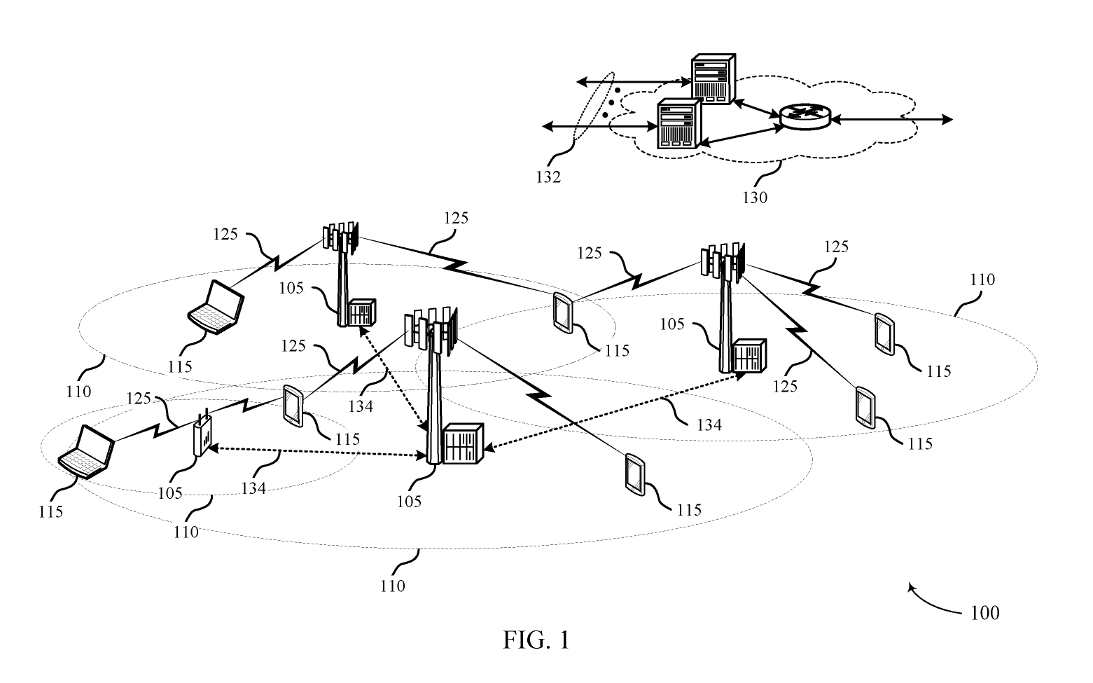

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE (e.g., or an LTE-Advanced) network. The wireless communications system 100 may support various aspects of the out of service recovery techniques described herein.

Base stations 105 may wirelessly communicate with UEs 115 (e.g., using various RATs or wireless technologies) via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105. In some examples, base stations 105 may be macro cells, small cells, hot spots, or the like. A base station 105 may also be referred to as an access point (“AP”), a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

Wireless communication system 100 may support different layers for cellular communications. An RRC protocol handles the Layer 3 control plane signaling by which a network (e.g., an evolved universal terrestrial access network (E-UTRAN)) controls the UE behavior. The RRC protocol supports the transfer of both common and dedicated NAS information. The RRC protocol covers a number of functional areas including system information (SI) broadcasting, connection control including handover within LTE, network-controlled inter-RAT mobility and measurement configuration and reporting. The NAS protocol generally concerns functions that are not specific to a particular RAT.

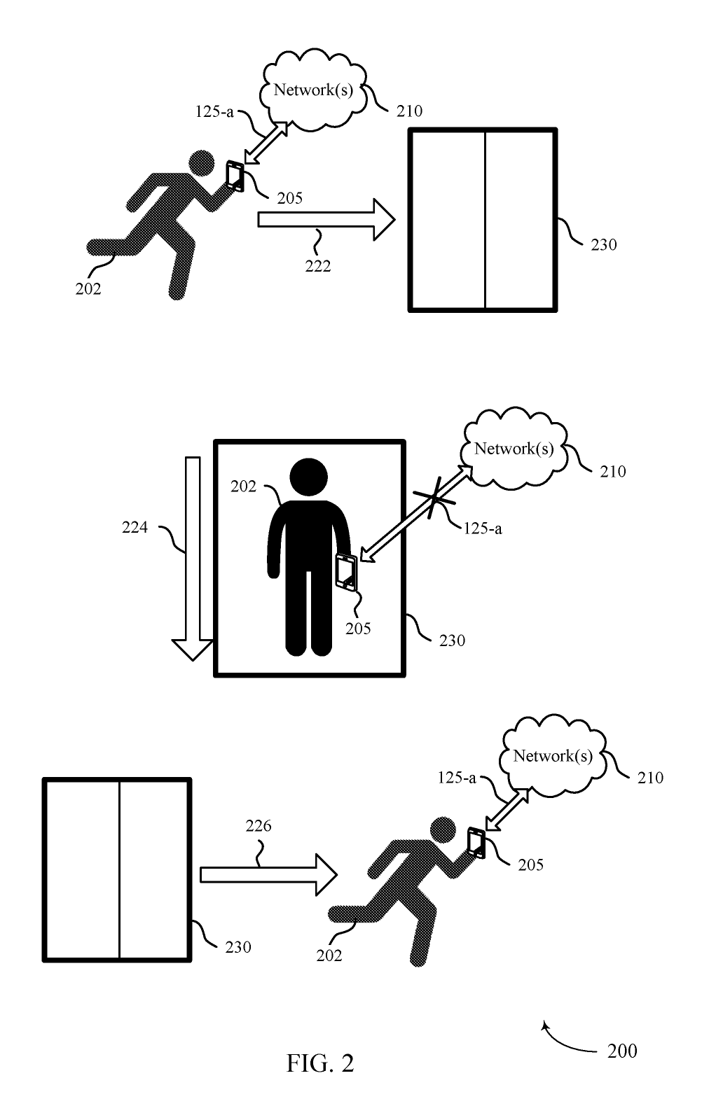

UE(s) 115 of wireless communications system 100 may support improved radio access out of service recovery techniques, such as is described with reference to FIGS. 2-4.

FIG. 2 illustrates an example of an out of service scenario 200 in which radio access out of service recovery techniques are performed in accordance with aspects of the present disclosure. Wireless device 205 may be an example of aspects of a UE 115 as described with reference to FIG. 1. When presented with an out of service scenario such as the out of service scenario 200, wireless device 205 may employ further intelligence for recovering LTE service by performing one or more of the access out of service recovery techniques described in the disclosure.

A user 202 of wireless device 205 may be connected to an LTE network of the plurality of networks 210 available for use with wireless device 205 while walking toward 222 an elevator 230. Additionally, the user 202 may be actively engaged in using a service or application associated with the wireless device 205 and the LTE network while walking 222 toward the elevator 230. In this environment, some or all of the plurality of networks 210 (e.g., networks associated with LTE, WCDMA, and GSM systems), but the wireless device 205 is connected via communication link 125-a to the preferred network (e.g., the LTE network in this example).

When the user 202 enters and is riding down 224 the elevator 230, communication link 125-a between the wireless device 205 and the plurality of networks 210 is severed (e.g., at least communications to the LTE network is severed, but communications to each of the plurality of networks 210 may likewise be severed). When the wireless device 202 temporarily loses LTE service, the wireless device 202 begins an out of service search. As the out of service search may eventually lead to a full search of all available RATs, but whereas LTE service could actually become available again to the UE before the full search is complete, aspects of the disclosure provide a way to shortcut the full search of all available RATs. That is, the wireless device 205 may reconnect or recouple to or reestablish LTE service without cycling through the full out of service search and all RATs and RF bands thereof. In scenario 200, for example, when the wireless device 205 temporarily loses LTE service, wireless device 205 may begin to search for LTE service on all known LTE RF bands and all known LTE networks (e.g., those LTE RF band and LTE networks that are known to the wireless device 205 based on previously established connectivity and/or previous registration information received). Wireless device 205, however, may unsuccessfully reconnect or recouple to or reestablish LTE service while riding down 224 the elevator 230.

Thus, the wireless device 205 may attempt to establish service with another RAT (e.g., WCDMA) that is identified as a next RAT to try in the RAT search cycle for the wireless device 205. For example, the wireless device 205 may attempt to establish service on a WCDMA RF band, but still fail to establish connectivity while riding down 224 the elevator 230. The wireless device 205 may identify that an RF spectrum overlap exists in which at least one LTE RF band overlaps with the WCDMA RF band. As the user 202 is exiting and walking away 226 from the elevator 230, the wireless device 205 may scan for RF energy corresponding to the WCDMA RF band. At this time, however, the wireless device 205 may detect the RF energy in the WCDMA RF band. Because the WCDMA RF band overlaps with at least one LTE RF band (e.g., one or more LTE RF bands associated with the initial search for LTE service), the wireless device 205 may perform a subsequent search for LTE service on all known LTE RF bands. Because the communication link 125-a between the wireless device 205 and the plurality of networks 210 has been reestablished when the user 202 is walking away 226 from the elevator 230, the subsequent search for LTE service will be successful.

In this manner, additional time searching for service on other WCDMA RF bands and/or GSM RF bands can be avoided (e.g., if the wireless device 205 is unable to connect or couple to a WCDMA network and/or GSM network in the RAT search cycle because the wireless device 205 has recently entered an LTE-only coverage area). Similarly, less efficient and/or less desirable network connectivity can be avoided by reestablishing the desirable LTE network (e.g., if the wireless device 205 is able to connect or couple to one of several concurrently available networks such as the LTE, WCDMA, and/or GSM networks). As noted above, it is to be appreciated that other reasons besides RF signal isolation or attenuation may cause the wireless device 205 from establishing a connection with a network of a RAT. For example, one or more RF bands in a network of a particular RAT that is listed in the RAT search cycle may be inaccessible to wireless device 205 (e.g., based on network access privileges being denied (e.g., temporarily denied) or restricted to that particular RF band and/or network associated with the RAT) despite sufficient RF signal strength being present with which to establish communications with the RAT.

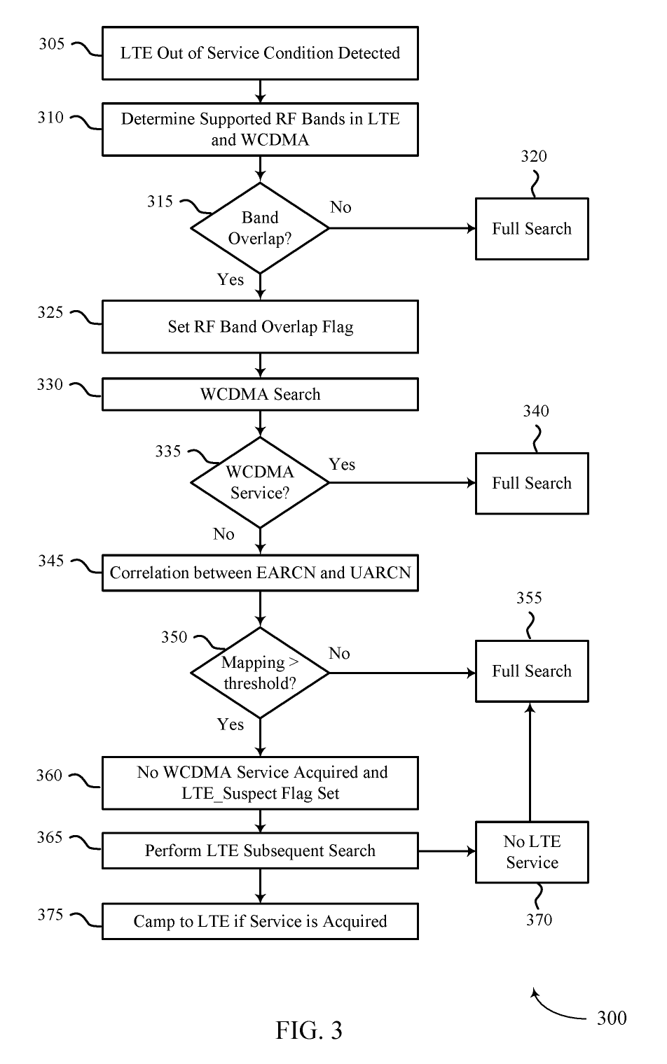

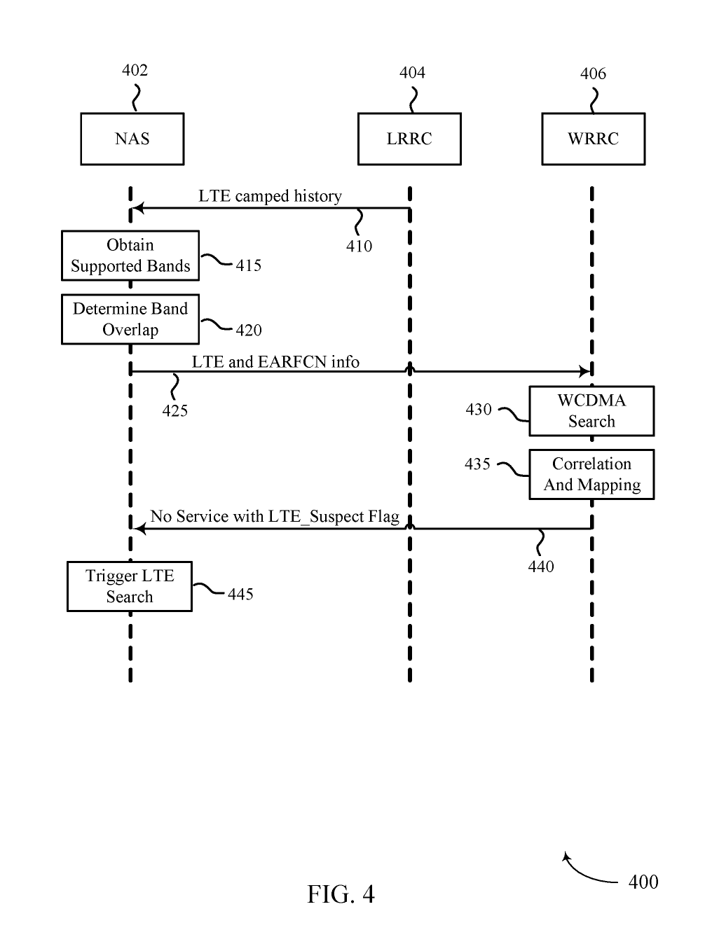

FIG. 3 illustrates an example of a process flow 300 that describes radio access out of service recovery techniques in accordance with aspects of the present disclosure. Process flow 300 may be performed by a UE 115 as described with reference to FIG. 1 or a wireless device 205 as described with reference to FIG. 2. FIG. 4 illustrates an example of a protocol-layer process flow 400 that describes radio access out of service recovery techniques in accordance with aspects of the present disclosure. Like process flow 300, protocol-layer process flow 400 may be may be performed by a UE 115 as described with reference to FIG. 1 or a wireless device 205 as described with reference to FIG. 2.

FIGS. 3 and 4 and corresponding process flow 300 and protocol-layer process flow 400, respectively, are described concurrently for completeness. It is to be understood, however, that in some examples, certain devices may perform the operations of process flow 300 without one or more of the example implementation details provided by the protocol-layer process flow 400. Additionally or alternatively, aspects of the example implementation details provided by the protocol-layer process flow 400 may be performed by other devices without performing one or more of the explicit operations described in process flow 300.

Process flow 300 may be used when a UE temporarily loses LTE service and begins an out of service search. As the out of service search may eventually lead to a full search of all available RATs (e.g., RAT search cycle), but whereas LTE service could actually become available again to the UE before the full search is complete, techniques are provided to shortcut or interrupt the full search—reconnect or recouple to an LTE service without cycling through a full search of all available RATs. For example, a UE experiencing mobility or a UE that enters an elevator and loses LTE service while in the elevator could very well have LTE service available again before the UE is able to complete a full out of service search.

At operation 305, an LTE out of service condition may be detected, and the UE 115, for example, the LTE RRC protocol-layer entity 404 may send 410 LTE camped history to NAS protocol-layer entity 402. For example, an LTE RRC protocol layer message may be sent to the NAS protocol layer indicating a list of successfully camped evolved universal terrestrial radio access (E-UTRA) absolute RF channel numbers (EARFCNs) and associated bandwidths. In some cases, this list can vary based on network deployments with different radio frequencies and other network characteristics. At operation 310, the UE 115, for example, the NAS protocol-layer entity 402 may obtain the supported LTE RF bands 415 from this list and may store or cache the list and/or associated information.

At operation 315, the UE 115, for example, the NAS protocol-layer entity 402 may perform an RF overlap search process to compare the LTE RF bands from the list of successfully camped EARFCN information with the supported WCDMA RF bands to determine if there is any RF band overlap 420 between these supported RF bands. If there is no RF band overlap, the NAS protocol-layer entity 402 may perform or continue a full out of service search (operation 320). In some cases, the full out of service search may correspond to a legacy out of service search as described in the relevant 3GPP specifications.

If, however there is an RF band overlap, the NAS protocol-layer entity 402 may set an RF spectrum overlap indicator (e.g., an LTE/WCDMA_Band_Overlap flag) based on determining an overlap of radio frequencies in these two RATs (operation 325). The UE 115, for example, the NAS protocol-layer entity 402 may then send 425 the LTE RF bands and successfully camped EARFCN information to a WCDMA RRC protocol-layer entity 406.

In operation 330, the UE 115, for example, the NAS protocol-layer entity 402 may then instruct the WCDMA RRC protocol-layer entity 406 to perform an out of service search on one or more WCDMA RF bands supported by the UE. The UE 115, for example, the WCDMA RRC protocol-layer entity 406 may then execute the WCDMA out of service search 430 on the one or more WCDMA RF band. The UE 115, for example, the WCDMA RRC protocol-layer entity 406 may determine whether the WCDMA out of service search is successful and WCDMA service is acquired (operation 335). If WCDMA service is successfully acquired, the WCDMA RRC protocol-layer entity 406 may notify the NAS protocol-layer entity 402, which may continue or complete certain operations associated with the full out of service search (operation 340). For example, the WCDMA RRC protocol-layer entity 406 may initiate an out of service search with respect to a first WCDMA band. If service can be acquired on an RPLMN corresponding to the first WCDMA band, the service acquisition and camping process continues in WCDMA for that RPLMN.

If, however, the WCDMA service is not successfully acquired, the UE 115, for example, the WCDMA RRC protocol-layer entity 406 may perform a correlation and mapping function 435. For example, a mapping or overlap comparison is performed to provide RF spectrum overlap information (e.g., a universal terrestrial radio access (UTRA) absolute RF channel number (UARFCN)-to-EARFCN RF mapping table or the like). In operation 345, this RF overlap information is then used to determine whether there is an RF overlap or correlation between the particular WCDMA RF band being searched and an LTE RF band associated with the list of successfully camped EARFCN information.

The UE 115, for example, the WCDMA RRC protocol-layer entity 406 may perform an RF scan to detect and measure RF energy in the first band (e.g., scanning within a 10 MHz frequency range of a center or middle frequency of the first WCDMA band). Based on this RF scan, the WCDMA RRC protocol-layer entity 406 may determine if there is RF energy seen in UARFCN that matches an EARFCN, and, if so, whether that RF energy satisfies or is above a pre-determined LTE presence threshold (operation 350).

If the RF energy does not satisfy or is not above the pre-determined LTE presence threshold (e.g., the pre-determined LTE presence threshold is not satisfied and operable communications associated with the LTE network cannot be performed), then the UE 115, for example, the WCDMA RRC protocol-layer entity 406 may notify the NAS protocol-layer entity 402, one or both of which may continue or complete certain operations associated with the full out of service search (operation 355).

If the RF energy is determined to satisfy or be above the pre-determined threshold (e.g., the pre-determined LTE presence threshold is satisfied and operable communications associated with the LTE network can be performed), the UE 115, for example, the WCDMA RRC protocol-layer entity 406 may, at operation 360, set a RAT suspect indicator (e.g., an LTE_Suspect flag) and send 440 this RAT suspect indicator to the NAS protocol-layer entity 402.

Upon receiving the RAT suspect indicator (e.g., the LTE_Suspect flag), the UE 115, for example, the NAS protocol-layer entity 402 may configure a Search_Continue_RAT parameter. The Search_Continue_RAT parameter may be set to identify the RAT (e.g., 1 for LTE, 2 for WCDMA, 3 for GSM, etc.) at which the frequency overlap search process was interrupted to search for an LTE RPLMN and that additional searches with respect to that RAT are to be performed (e.g., a second WCDMA band and a third WCDMA band) or set to identify another RAT (e.g., 1 for LTE, 2 for WCDMA, 3 for GSM, etc.) for which searches with respect to such RAT are to be performed.

At operation 365, the UE 115, for example, the NAS protocol-layer entity 402 may trigger an LTE search 445 and may instruct the LTE RRC protocol-layer entity 404 to perform an LTE subsequent search (e.g., an LTE acquisition database search) to attempt to acquire service and camp on an LTE RPLMN based on the RF energy detected from during the RF scan associated with the search performed with respect to the first WCDMA RF band.

If no LTE service is acquired with respect to the LTE subsequent search (operation 370), the UE 115, for example, the LTE RRC protocol-layer entity 404 may notify the NAS protocol-layer entity 402. Then, one or both of the NAS protocol-layer entity 402 and the WCDMA RRC protocol-layer entity 406 may continue or complete certain operations associated with the full out of service search (operation 355). For example, the NAS protocol layer may check the Search_Continue_RAT parameter to determine whether further searching is required with respect to the RAT search that was interrupted based on the suspicion of LTE service available or whether to perform a full out of service search on all supported bands of a next RAT (e.g., a GSM network). If, however, service can be acquired on an LTE RPLMN, the service acquisition and camping process continues in LTE for that RPLMN (operation 375).

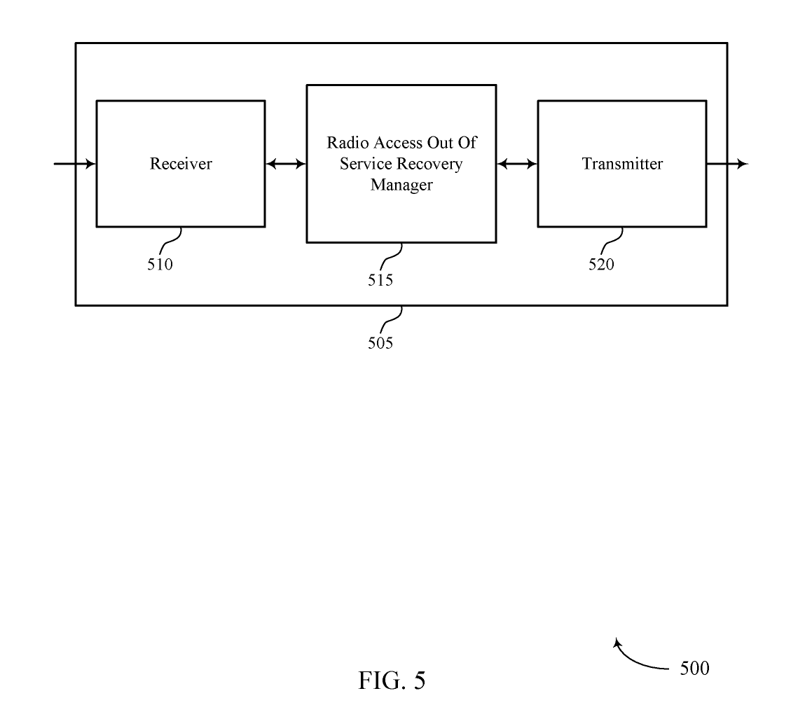

FIG. 5 shows a block diagram 500 of a wireless device 505 that supports providing radio access out of service recovery in accordance with various aspects of the present disclosure. Wireless device 505 may be an example of aspects of a UE 115 as described with reference to FIG. 1. Wireless device 505 may include receiver 510, radio access out of service recovery manager 515, and transmitter 520. Wireless device 505 may also include a processor. Each of these components may be in communication with one another (e.g., via one or more buses).

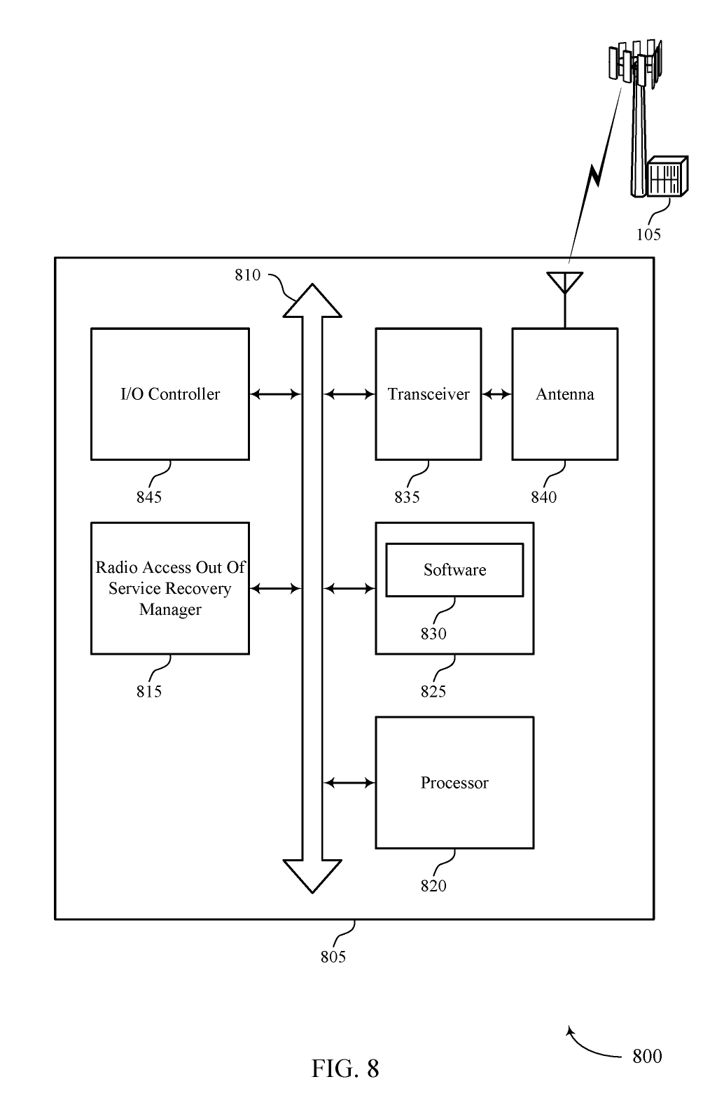

Receiver 510 may receive information such as packets, user data, or control information associated with various information channels (e.g., control channels, data channels, and information related to providing radio access out of service recovery, etc.). Information may be passed on to other components of the device. The receiver 510 may be an example of aspects of the transceiver 835 described with reference to FIG. 8.

Radio access out of service recovery manager 515 may be an example of aspects of the radio access out of service recovery manager 815 described with reference to FIG. 8.

Radio access out of service recovery manager 515 may search for a first network associated with a first RAT during a first time period in a RAT search cycle, and search, when service is not acquired with respect to the first RAT, for a second network associated with a second RAT during a second time period in the RAT search cycle. Radio access out of service recovery manager 515 may identify an RF spectrum overlap in which a first RF band associated with the first RAT overlaps with a second RF band associated with the second RAT. Radio access out of service recovery manager 515 may scan, when service is not acquired with respect to the second RAT, for RF energy corresponding to the second RF band of the second RAT, and determine, based on the scanning, whether to perform a subsequent search for the first network in the first RF band of the first RAT.

Transmitter 520 may transmit signals generated by other components of the device. In some examples, the transmitter 520 may be collocated with a receiver 510 in a transceiver module. For example, the transmitter 520 may be an example of aspects of the transceiver 835 described with reference to FIG. 8. The transmitter 520 may include a single antenna, or it may include a set of antennas.

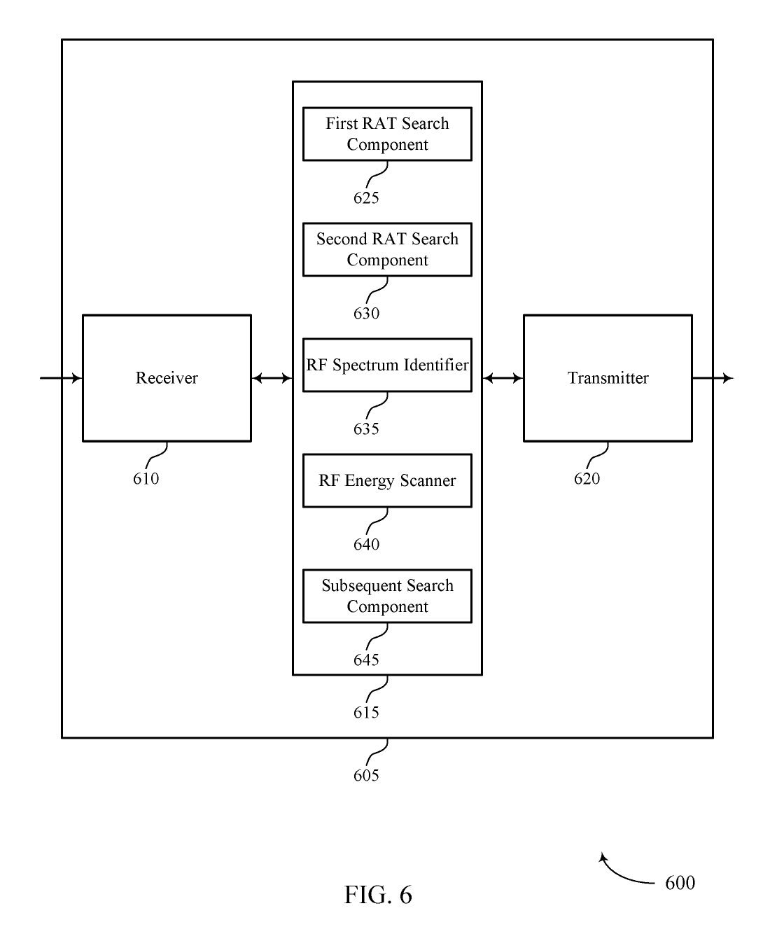

FIG. 6 shows a block diagram 600 of a wireless device 605 that supports providing radio access out of service recovery in accordance with various aspects of the present disclosure. Wireless device 605 may be an example of aspects of a wireless device 505 or a UE 115 as described with reference to FIGS. 1 and 5. Wireless device 605 may include receiver 610, radio access out of service recovery manager 615, and transmitter 620. Wireless device 605 may also include a processor. Each of these components may be in communication with one another (e.g., via one or more buses).

Receiver 610 may receive information such as packets, user data, or control information associated with various information channels (e.g., control channels, data channels, and information related to providing radio access out of service recovery, etc.). Information may be passed on to other components of the device. The receiver 610 may be an example of aspects of the transceiver 835 described with reference to FIG. 8.

Radio access out of service recovery manager 615 may be an example of aspects of the radio access out of service recovery manager 815 described with reference to FIG. 8.

Radio access out of service recovery manager 615 may also include first RAT search component 625, second RAT search component 630, RF spectrum identifier 635, RF energy scanner 640, and subsequent search component 645.

First RAT search component 625 may search for a first network associated with a first RAT during a first time period in a RAT search cycle.

Second RAT search component 630 may search, when service is not acquired with respect to the first RAT, for a second network associated with a second RAT during a second time period in the RAT search cycle.

RF spectrum identifier 635 may identify an RF spectrum overlap in which a first RF band associated with the first RAT overlaps with a second RF band associated with the second RAT.

RF energy scanner 640 may scan, when service is not acquired with respect to the second RAT, for RF energy corresponding to the second RF band of the second RAT. In some cases, the scanning for RF energy corresponding to the second RF band includes scanning, based on the mapping, for RF energy corresponding to the second RF band of the second RAT.

Subsequent search component 645 may determine, based on the scanning, whether to perform a subsequent search for the first network in the first RF band of the first RAT. Subsequent search component 645 may also perform the subsequent search for the first network when the RF energy satisfies a threshold for operable communications associated with the first RAT. Additionally, the subsequent search component 645 may perform, based on the first RAT suspect indicator, the subsequent search for the first network. In some cases, the subsequent search component 645 may acquire service with respect to the first RAT based on the subsequent search, without searching for a third network associated with a third RAT during a third time period in the RAT search cycle. In some cases, the subsequent search for the first network includes an LTE acquisition database scan.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may include a single antenna, or it may include a set of antennas.

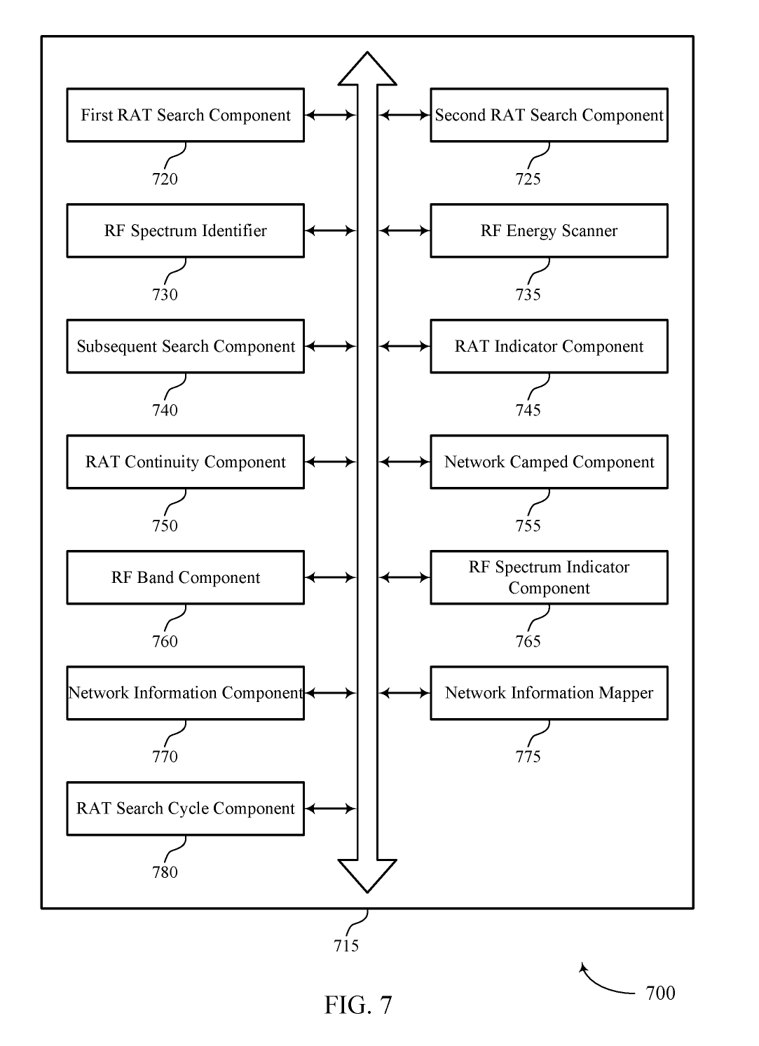

FIG. 7 shows a block diagram 700 of a radio access out of service recovery manager 715 that supports providing radio access out of service recovery in accordance with various aspects of the present disclosure. The radio access out of service recovery manager 715 may be an example of aspects of a radio access out of service recovery manager 515, a radio access out of service recovery manager 615, or a radio access out of service recovery manager 815 described with reference to FIGS. 5, 6, and 8. The radio access out of service recovery manager 715 may include first RAT search component 720, second RAT search component 725, RF spectrum identifier 730, RF energy scanner 735, subsequent search component 740, RAT indicator component 745, RAT continuity component 750, network camped component 755, RF band component 760, RF spectrum indicator component 765, network information component 770, network information mapper 775, and RAT search cycle component 780. Each of these modules may communicate, directly or indirectly, with one another (e.g., via one or more buses).

First RAT search component 720 may search for a first network associated with a first RAT during a first time period in a RAT search cycle.

Second RAT search component 725 may search, when service is not acquired with respect to the first RAT, for a second network associated with a second RAT during a second time period in the RAT search cycle.

RF spectrum identifier 730 may identify a radio frequency (RF) spectrum overlap in which a first RF band associated with the first RAT overlaps with a second RF band associated with the second RAT.

RF energy scanner 735 may scan, when service is not acquired with respect to the second RAT, for RF energy corresponding to the second RF band of the second RAT. In some cases, the scanning for RF energy corresponding to the second RF band includes scanning, based on the mapping, for RF energy corresponding to the second RF band of the second RAT.

Subsequent search component 740 may determine, based on the scanning, whether to perform a subsequent search for the first network in the first RF band of the first RAT. Subsequent search component 740 may also perform the subsequent search for the first network when the RF energy satisfies a threshold for operable communications associated with the first RAT. Additionally, subsequent search component 740 may perform, based on the first RAT suspect indicator, the subsequent search for the first network. In some cases the subsequent search component 740 may acquire service with respect to the first RAT based on the subsequent search, without searching for a third network associated with a third RAT during a third time period in the RAT search cycle. In some cases, the subsequent search for the first network includes an LTE acquisition database scan.

RAT indicator component 745 may set, based on scanning for RF energy, a first RAT suspect indicator and send the first RAT suspect indicator to a non-access stratum layer entity.

RAT continuity component 750 may set, based on scanning for RF energy, a RAT search continuity parameter to identify the second RAT for further searching of one or more additional RF bands associated with the second RAT if service is not acquired with respect to the first RAT based on the subsequent search. The RAT continuity component 750 may also set, based on scanning for RF energy, a RAT search continuity parameter to identify a third RAT for further searching if service is not acquired with respect to the first RAT based on the subsequent search.

Network camped component 755 may send, when service is not acquired with respect to the first RAT, first network camped history information to a non-access stratum entity.

RF band component 760 may determine, prior to identifying the RF spectrum overlap, that the first RF band associated with the first RAT is included in the first network camped history information.

RF spectrum indicator component 765 may set, based on the identifying the RF spectrum overlap, an RF spectrum overlap indicator.

Network information component 770 may send, based on the RF spectrum overlap, network information associated with the first RAT to a radio resource entity associated with the second RAT. In some cases, sending network information associated with the first RAT includes sending, by a non-access stratum layer entity, network information including the first RF band and at least one EARFCN to the radio resource entity associated with the second RAT.

Network information mapper 775 may map, by the radio resource entity associated with the second RAT, the network information associated with the first RAT to the second RF band and at least one UARFCN.

RAT search cycle component 780 may provide a RAT search cycle. In some cases, the RAT search cycle includes a sequential order of RATs to be searched that includes at least one of searching the first RAT during the first time period, searching the second RAT during the second time period, or searching a third RAT during a third time period. In some cases, the second RAT is different from the first RAT and the third RAT is different from the first RAT and the second RAT.

FIG. 8 shows a diagram of a system 800 including a device 805 that supports providing radio access out of service recovery in accordance with various aspects of the present disclosure. Device 805 may be an example of or include the components of wireless device 505, wireless device 605, or a UE 115 as described above, e.g., with reference to FIGS. 1, 5 and 6. Device 805 may include components for bi-directional voice and data communications including components for transmitting and receiving communications, including radio access out of service recovery manager 815, processor 820, memory 825, software 830, transceiver 835, antenna 840, and I/O controller 845. These components may be in electronic communication via one or more busses (e.g., bus 810). Device 805 may communicate wirelessly with one or more base stations 105.

Processor 820 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute one or more computer-readable instructions stored in a memory to perform various functions (e.g., functions or tasks supporting providing radio access out of service recovery).

Memory 825 may include random access memory (RAM) and read only memory (ROM). The memory 825 may store computer-readable, computer-executable software 830 including one or more instructions that, when executed, cause the processor to perform various functions described herein. In some cases, the memory 825 may contain, among other things, a basic input/output system (BIOS) which may control basic hardware and/or software operation such as the interaction with peripheral components or devices.

Software 830 may include code to implement aspects of the present disclosure, including code to support providing radio access out of service recovery. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

I/O controller 845 may manage input and output signals for device 805. I/O controller 845 may also manage peripherals not integrated into device 805. In some cases, I/O controller 845 may represent a physical connection or port to an external peripheral. In some cases, I/O controller 845 may utilize an operating system such as iOS®, ANDROID®, MS-DOS®, MS-WINDOWS®, OS/2®, UNIX®, LINUX®, or another known operating system.

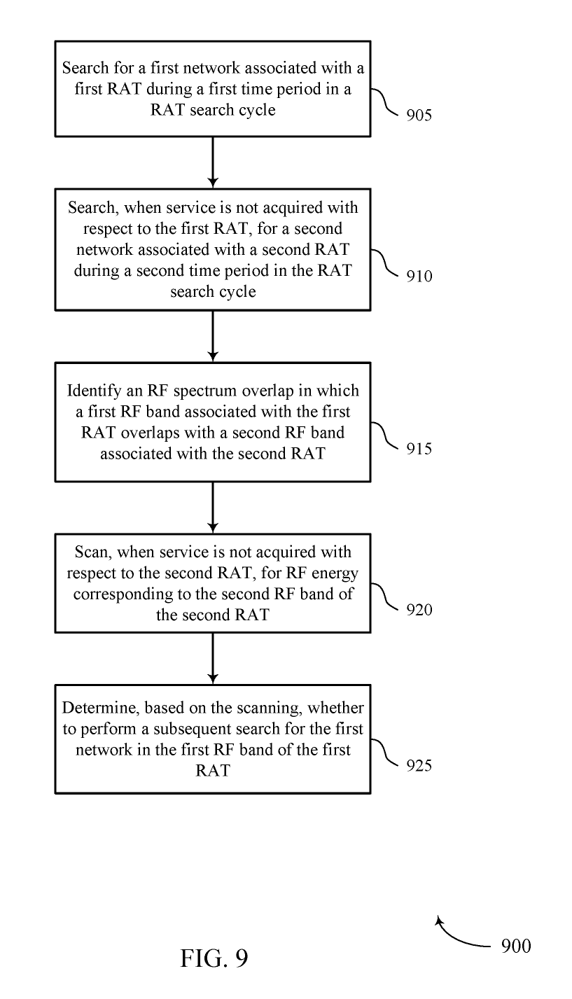

FIG. 9 shows a flowchart illustrating a method 900 for providing radio access out of service recovery in accordance with various aspects of the present disclosure. The operations of method 900 may be implemented by a UE 115 or its components as described herein. For example, the operations of method 900 may be performed by a radio access out of service recovery manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 905 the UE 115 may search for a first network associated with a first RAT during a first time period in a RAT search cycle. The operations of block 905 may be performed according to the methods described with reference to FIGS. 1 through 4. In certain examples, aspects of the operations of block 905 may be performed by a first RAT search component as described with reference to FIGS. 5 through 8.

At block 910 the UE 115 may search, when service is not acquired with respect to the first RAT, for a second network associated with a second RAT during a second time period in the RAT search cycle. The operations of block 910 may be performed according to the methods described with reference to FIGS. 1 through 4. In certain examples, aspects of the operations of block 910 may be performed by a second RAT search component as described with reference to FIGS. 5 through 8.

At block 915 the UE 115 may identify an RF spectrum overlap in which a first RF band associated with the first RAT overlaps with a second RF band associated with the second RAT. The operations of block 915 may be performed according to the methods described with reference to FIGS. 1 through 4. In certain examples, aspects of the operations of block 915 may be performed by an RF spectrum identifier as described with reference to FIGS. 5 through 8.

At block 920 the UE 115 may scan, when service is not acquired with respect to the second RAT, for RF energy corresponding to the second RF band of the second RAT. The operations of block 920 may be performed according to the methods described with reference to FIGS. 1 through 4. In certain examples, aspects of the operations of block 920 may be performed by an RF energy scanner as described with reference to FIGS. 5 through 8.

At block 925 the UE 115 may determine, based at least in part on the scanning, whether to perform a subsequent search for the first network in the first RF band of the first RAT. The operations of block 925 may be performed according to the methods described with reference to FIGS. 1 through 4. In certain examples, aspects of the operations of block 925 may be performed by a subsequent search component as described with reference to FIGS. 5 through 8.

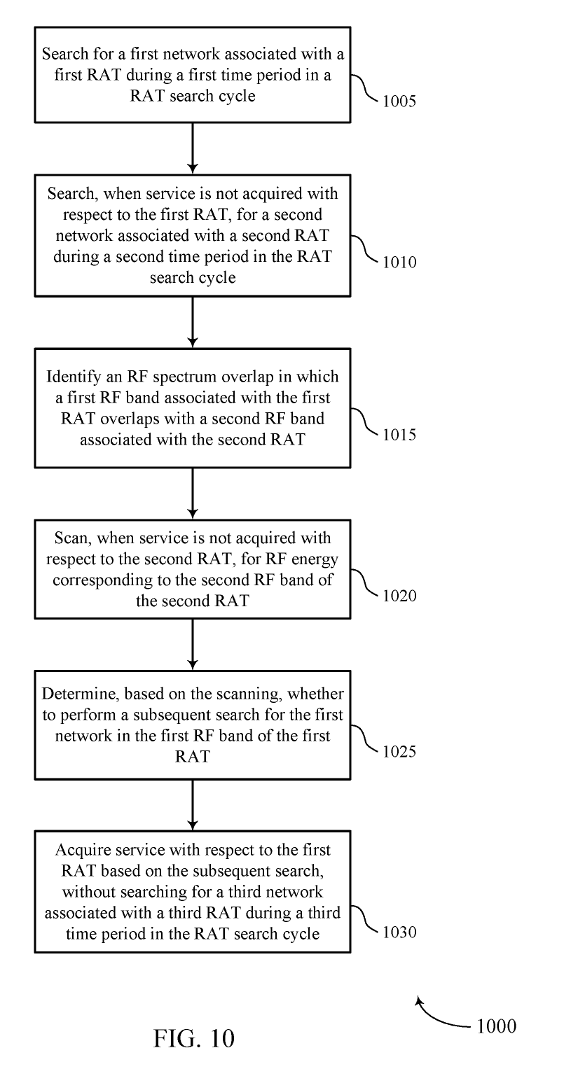

FIG. 10 shows a flowchart illustrating a method 1000 for providing radio access out of service recovery in accordance with various aspects of the present disclosure. The operations of method 1000 may be implemented by a UE 115 or its components as described herein. For example, the operations of method 1000 may be performed by a radio access out of service recovery manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1005 the UE 115 may search for a first network associated with a first RAT during a first time period in a RAT search cycle. The operations of block 1005 may be performed according to the methods described with reference to FIGS. 1 through 4. In certain examples, aspects of the operations of block 1005 may be performed by a first RAT search component as described with reference to FIGS. 5 through 8.

At block 1010 the UE 115 may search, when service is not acquired with respect to the first RAT, for a second network associated with a second RAT during a second time period in the RAT search cycle. The operations of block 1010 may be performed according to the methods described with reference to FIGS. 1 through 4. In certain examples, aspects of the operations of block 1010 may be performed by a second RAT search component as described with reference to FIGS. 5 through 8.

In some examples, the RAT search cycle includes a sequential order of RATs to be searched that includes at least one of searching the first RAT during the first time period, searching the second RAT during the second time period, or searching a third RAT during a third time period. For example, the RAT search cycle may include searching the first RAT during the first time period and then searching the second RAT (e.g., all RF bands associated with the second RAT) during the second time period, and then after all RF bands associated with the second RAT have been searched, return to searching the first RAT during a next time period. In other examples, the RAT search cycle may include searching the first RAT during the first time period, searching the second RAT (e.g., all RF bands associated with the second RAT) during the second time period, and searching the third RAT (e.g., all RF bands associated with the third RAT) during the third time period. Then after all RF bands associated with the third RAT have been searched, return to searching the first RAT during a next time period.

Further, in some cases, the second RAT may be different from the first RAT and the third RAT may be different from the first RAT and the second RAT. For example, in some examples, the first RAT is LTE, the second RAT is WCDMA, and the third RAT is GSM. In other examples, however, the second RAT can be a same or similar technology as the first RAT, but a different version or alternative of the first RAT (e.g., the second RAT being LTE-A, LTE-U, LTE Release 13, or the like when the first RAT is LTE Release 9). In this regard, although the first and second RATs may be considered as using the same or similar radio access technologies, the first and second RATs may be designed as distinct networks and/or technology subsets in accordance with aspects of the subject technology.

At block 1015 the UE 115 may identify an RF spectrum overlap in which a first RF band associated with the first RAT overlaps with a second RF band associated with the second RAT. In some cases, an RF spectrum overlap indicator may be set based at least in part on the identifying the RF spectrum overlap. For example, the RF spectrum overlap indicator can be a flag that indicates at least some RF spectrum in the first RAT (e.g., LTE) overlaps with at least some RF spectrum in the second RAT (e.g., WCDMA). The operations of block 1015 may be performed according to the methods described with reference to FIGS. 1 through 4. In certain examples, aspects of the operations of block 1015 may be performed by an RF spectrum identifier as described with reference to FIGS. 5 through 8.

At block 1020 the UE 115 may scan, when service is not acquired with respect to the second RAT, for RF energy corresponding to the second RF band of the second RAT. The operations of block 1020 may be performed according to the methods described with reference to FIGS. 1 through 4. In certain examples, aspects of the operations of block 1020 may be performed by an RF energy scanner as described with reference to FIGS. 5 through 8.

At block 1025 the UE 115 may determine, based at least in part on the scanning, whether to perform a subsequent search for the first network in the first RF band of the first RAT. For example, the UE 115 may perform the subsequent search for the first network when the RF energy satisfies a threshold for operable communications associated with the first RAT. In some cases, the subsequent search for the first network may include an LTE acquisition database scan. The operations of block 1025 may be performed according to the methods described with reference to FIGS. 1 through 4. In certain examples, aspects of the operations of block 1025 may be performed by a subsequent search component as described with reference to FIGS. 5 through 8.

In some cases, the UE may send, when service is not acquired with respect to the first RAT, first network camped history information to a non-access stratum entity and may then determine, prior to identifying the RF spectrum overlap, that the first RF band associated with the first RAT is included in the first network camped history information.

At block 1030 the UE 115 may acquire service with respect to the first RAT based at least in part on the subsequent search, without searching for a third network associated with a third RAT during a third time period in the RAT search cycle. The operations of block 1030 may be performed according to the methods described with reference to FIGS. 1 through 4. In certain examples, aspects of the operations of block 1030 may be performed by a subsequent search component as described with reference to FIGS. 5 through 8.

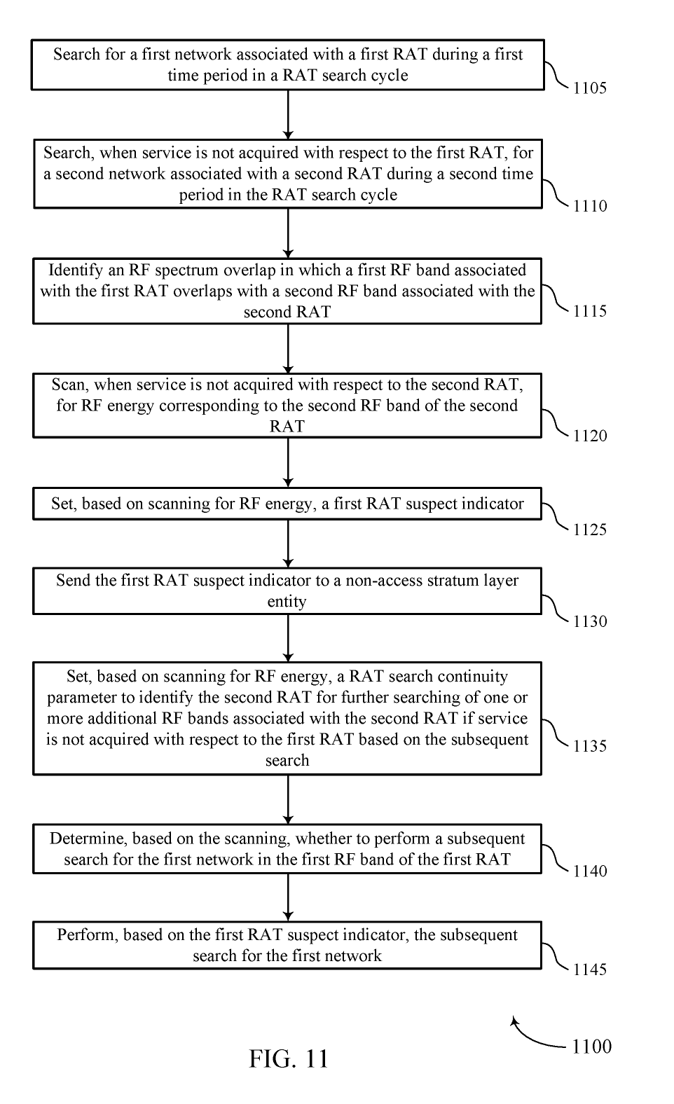

FIG. 11 shows a flowchart illustrating a method 1100 for providing radio access out of service recovery in accordance with various aspects of the present disclosure. The operations of method 1100 may be implemented by a UE 115 or its components as described herein. For example, the operations of method 1100 may be performed by a radio access out of service recovery manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1105 the UE 115 may search for a first network associated with a first RAT during a first time period in a RAT search cycle. The operations of block 1105 may be performed according to the methods described with reference to FIGS. 1 through 4. In certain examples, aspects of the operations of block 1105 may be performed by a first RAT search component as described with reference to FIGS. 5 through 8.

At block 1110 the UE 115 may search, when service is not acquired with respect to the first RAT, for a second network associated with a second RAT during a second time period in the RAT search cycle. The operations of block 1110 may be performed according to the methods described with reference to FIGS. 1 through 4. In certain examples, aspects of the operations of block 1110 may be performed by a second RAT search component as described with reference to FIGS. 5 through 8.

At block 1115 the UE 115 may identify an RF spectrum overlap in which a first RF band associated with the first RAT overlaps with a second RF band associated with the second RAT. The operations of block 1115 may be performed according to the methods described with reference to FIGS. 1 through 4. In certain examples, aspects of the operations of block 1115 may be performed by an RF spectrum identifier as described with reference to FIGS. 5 through 8.

At block 1120 the UE 115 may scan, when service is not acquired with respect to the second RAT, for RF energy corresponding to the second RF band of the second RAT. The operations of block 1120 may be performed according to the methods described with reference to FIGS. 1 through 4. In certain examples, aspects of the operations of block 1120 may be performed by an RF energy scanner as described with reference to FIGS. 5 through 8.

At block 1125 the UE 115 may set, based at least in part on scanning for RF energy, a first RAT suspect indicator. The operations of block 1125 may be performed according to the methods described with reference to FIGS. 1 through 4. In certain examples, aspects of the operations of block 1125 may be performed by a RAT indicator component as described with reference to FIGS. 5 through 8.

At block 1130 the UE 115 may send the first RAT suspect indicator to a non-access stratum layer entity. The operations of block 1130 may be performed according to the methods described with reference to FIGS. 1 through 4. In certain examples, aspects of the operations of block 1130 may be performed by a RAT indicator component as described with reference to FIGS. 5 through 8.

At block 1135 the UE 115 may set, based at least in part on scanning for RF energy, a RAT search continuity parameter to identify the second RAT for further searching of one or more additional RF bands associated with the second RAT if service is not acquired with respect to the first RAT based at least in part on the subsequent search. The operations of block 1135 may be performed according to the methods described with reference to FIGS. 1 through 4. In certain examples, aspects of the operations of block 1135 may be performed by a RAT continuity component as described with reference to FIGS. 5 through 8.

At block 1140 the UE 115 may determine, based at least in part on the scanning, whether to perform a subsequent search for the first network in the first RF band of the first RAT. The operations of block 1140 may be performed according to the methods described with reference to FIGS. 1 through 4. In certain examples, aspects of the operations of block 1140 may be performed by a subsequent search component as described with reference to FIGS. 5 through 8.

At block 1145 the UE 115 may perform, based at least in part on the first RAT suspect indicator, the subsequent search for the first network. The operations of block 1145 may be performed according to the methods described with reference to FIGS. 1 through 4. In certain examples, aspects of the operations of block 1145 may be performed by a subsequent search component as described with reference to FIGS. 5 through 8.

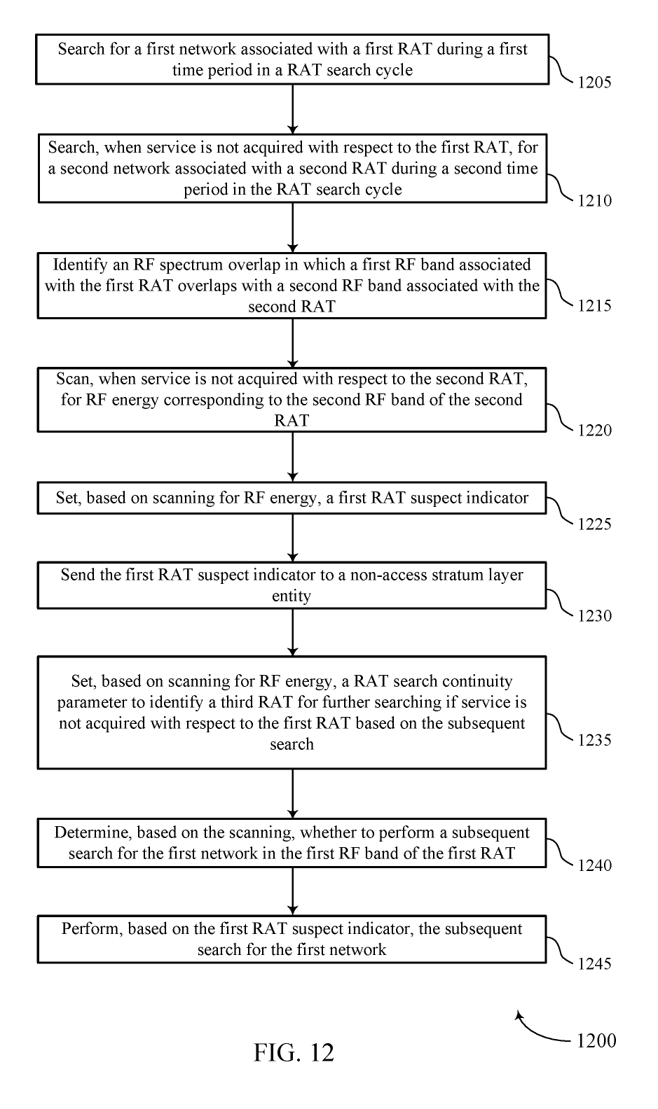

FIG. 12 shows a flowchart illustrating a method 1200 for providing radio access out of service recovery in accordance with various aspects of the present disclosure. The operations of method 1200 may be implemented by a UE 115 or its components as described herein. For example, the operations of method 1200 may be performed by a radio access out of service recovery manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1205 the UE 115 may search for a first network associated with a first RAT during a first time period in a RAT search cycle. The operations of block 1205 may be performed according to the methods described with reference to FIGS. 1 through 4. In certain examples, aspects of the operations of block 1205 may be performed by a first RAT search component as described with reference to FIGS. 5 through 8.

At block 1210 the UE 115 may search, when service is not acquired with respect to the first RAT, for a second network associated with a second RAT during a second time period in the RAT search cycle. The operations of block 1210 may be performed according to the methods described with reference to FIGS. 1 through 4. In certain examples, aspects of the operations of block 1210 may be performed by a second RAT search component as described with reference to FIGS. 5 through 8.

At block 1215 the UE 115 may identify an RF spectrum overlap in which a first RF band associated with the first RAT overlaps with a second RF band associated with the second RAT. The operations of block 1215 may be performed according to the methods described with reference to FIGS. 1 through 4. In certain examples, aspects of the operations of block 1215 may be performed by an RF spectrum identifier as described with reference to FIGS. 5 through 8.

At block 1220 the UE 115 may scan, when service is not acquired with respect to the second RAT, for RF energy corresponding to the second RF band of the second RAT. The operations of block 1220 may be performed according to the methods described with reference to FIGS. 1 through 4. In certain examples, aspects of the operations of block 1220 may be performed by an RF energy scanner as described with reference to FIGS. 5 through 8.

At block 1225 the UE 115 may set, based at least in part on scanning for RF energy, a first RAT suspect indicator. The operations of block 1225 may be performed according to the methods described with reference to FIGS. 1 through 4. In certain examples, aspects of the operations of block 1225 may be performed by a RAT indicator component as described with reference to FIGS. 5 through 8.

At block 1230 the UE 115 may send the first RAT suspect indicator to a non-access stratum layer entity. The operations of block 1230 may be performed according to the methods described with reference to FIGS. 1 through 4. In certain examples, aspects of the operations of block 1230 may be performed by a RAT indicator component as described with reference to FIGS. 5 through 8.

At block 1235 the UE 115 may set, based at least in part on scanning for RF energy, a RAT search continuity parameter to identify a third RAT for further searching if service is not acquired with respect to the first RAT based at least in part on the subsequent search. For example, if there is only one RF band associated with second RAT and service is not acquired with respect to the first RAT, the RAT search continuity parameter may be set to identify a third RAT for further searching if service is not acquired with respect to the first RAT. The operations of block 1235 may be performed according to the methods described with reference to FIGS. 1 through 4. In certain examples, aspects of the operations of block 1235 may be performed by a RAT continuity component as described with reference to FIGS. 5 through 8.

At block 1240 the UE 115 may determine, based at least in part on the scanning, whether to perform a subsequent search for the first network in the first RF band of the first RAT. The operations of block 1240 may be performed according to the methods described with reference to FIGS. 1 through 4. In certain examples, aspects of the operations of block 1240 may be performed by a subsequent search component as described with reference to FIGS. 5 through 8.

At block 1245 the UE 115 may perform, based at least in part on the first RAT suspect indicator, the subsequent search for the first network. The operations of block 1245 may be performed according to the methods described with reference to FIGS. 1 through 4. In certain examples, aspects of the operations of block 1245 may be performed by a subsequent search component as described with reference to FIGS. 5 through 8.

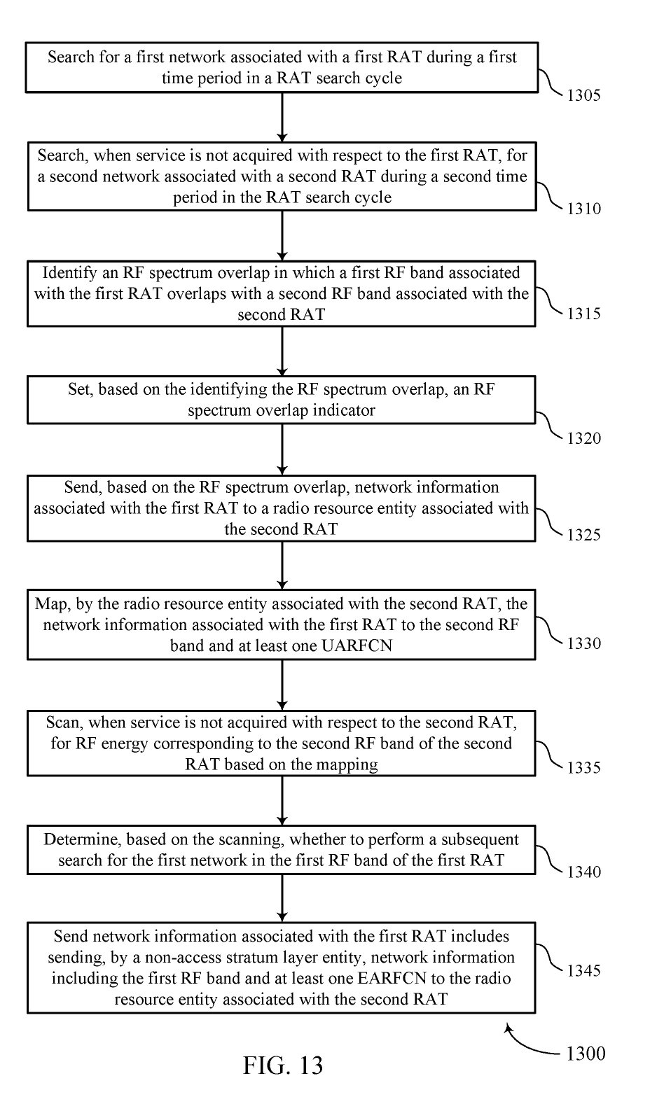

FIG. 13 shows a flowchart illustrating a method 1300 for providing radio access out of service recovery in accordance with various aspects of the present disclosure. The operations of method 1300 may be implemented by a UE 115 or its components as described herein. For example, the operations of method 1300 may be performed by a radio access out of service recovery manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1305 the UE 115 may search for a first network associated with a first RAT during a first time period in a RAT search cycle. The operations of block 1305 may be performed according to the methods described with reference to FIGS. 1 through 4. In certain examples, aspects of the operations of block 1305 may be performed by a first RAT search component as described with reference to FIGS. 5 through 8.

At block 1310 the UE 115 may search, when service is not acquired with respect to the first RAT, for a second network associated with a second RAT during a second time period in the RAT search cycle. The operations of block 1310 may be performed according to the methods described with reference to FIGS. 1 through 4. In certain examples, aspects of the operations of block 1310 may be performed by a second RAT search component as described with reference to FIGS. 5 through 8.

At block 1315 the UE 115 may identify an RF spectrum overlap in which a first RF band associated with the first RAT overlaps with a second RF band associated with the second RAT. The operations of block 1315 may be performed according to the methods described with reference to FIGS. 1 through 4. In certain examples, aspects of the operations of block 1315 may be performed by an RF spectrum identifier as described with reference to FIGS. 5 through 8.

At block 1320 the UE 115 may set, based at least in part on the identifying the RF spectrum overlap, an RF spectrum overlap indicator. The operations of block 1320 may be performed according to the methods described with reference to FIGS. 1 through 4. In certain examples, aspects of the operations of block 1320 may be performed by an RF spectrum indicator component as described with reference to FIGS. 5 through 8.

At block 1325 the UE 115 may send, based at least in part on the RF spectrum overlap, network information associated with the first RAT to a radio resource entity associated with the second RAT. In some examples, sending network information associated with the first RAT may include sending, by a non-access stratum layer entity, network information including the first RF band and at least one EARFCN to the radio resource entity associated with the second RAT. The operations of block 1325 may be performed according to the methods described with reference to FIGS. 1 through 4. In certain examples, aspects of the operations of block 1325 may be performed by a network information component as described with reference to FIGS. 5 through 8.

At block 1330 the UE 115 may map or associate, by the radio resource entity associated with the second RAT, the network information associated with the first RAT to the second RF band and at least one UARFCN. The operations of block 1330 may be performed according to the methods described with reference to FIGS. 1 through 4. In certain examples, aspects of the operations of block 1330 may be performed by a network information mapper as described with reference to FIGS. 5 through 8.

At block 1335 the UE 115 may scan, when service is not acquired with respect to the second RAT, for RF energy corresponding to the second RF band of the second RAT. In some examples, the UE may scan, based at least in part on the mapping or associating, for RF energy corresponding to the second RF band of the second RAT. The operations of block 1335 may be performed according to the methods described with reference to FIGS. 1 through 4. In certain examples, aspects of the operations of block 1335 may be performed by an RF energy scanner as described with reference to FIGS. 5 through 8.

At block 1340 the UE 115 may determine, based at least in part on the scanning, whether to perform a subsequent search for the first network in the first RF band of the first RAT. The operations of block 1340 may be performed according to the methods described with reference to FIGS. 1 through 4. In certain examples, aspects of the operations of block 1340 may be performed by a subsequent search component as described with reference to FIGS. 5 through 8.

At block 1345 the UE 115 may send network information associated with the first RAT comprises sending, by a non-access stratum layer entity, network information including the first RF band and at least one EARFCN to the radio resource entity associated with the second RAT. The operations of block 1345 may be performed according to the methods described with reference to FIGS. 1 through 4. In certain examples, aspects of the operations of block 1345 may be performed by a network information component as described with reference to FIGS. 5 through 8.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, UTRA, etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes WCDMA and other variants of CDMA. A time division multiple access (TDMA) system may implement a radio technology such as GSM.

An orthogonal frequency division multiple access (OFDMA) system may implement a radio technology such as Ultra Mobile Broadband (UMB), E-UTRA, Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP LTE and LTE-A are releases of Universal Mobile Telecommunications System (UMTS) that use E-UTRA. UTRA, E-UTRA, UMTS, LTE, LTE-A, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term eNB may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, an eNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of” ) indicates an inclusive list such that, for example, a phrase referring to “at least one of” a list of items refers to any combination of those items, including single members. As an example, “at least one of: a, b, or c” is intended to cover a, b, c, a-b, a-c, b-c, and a-b-c., as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
searching for a first network associated with a first radio access technology (RAT) during a first time period in a RAT search cycle;
searching, when service is not acquired with respect to the first RAT, for a second network associated with a second RAT during a second time period in the RAT search cycle;
identifying a radio frequency (RF) spectrum overlap in which a first RF band associated with the first RAT overlaps with a second RF band associated with the second RAT;
scanning, when service is not acquired with respect to the second RAT, for RF energy corresponding to the second RF band of the second RAT; and
determining, based at least in part on the scanning, whether to perform a subsequent search for the first network in the first RF band of the first RAT.

2. The method of claim 1, further comprising:
performing the subsequent search for the first network when the RF energy satisfies a threshold for operable communications associated with the first RAT.

3. The method of claim 1, further comprising:
setting, based at least in part on scanning for RF energy, a first RAT suspect indicator; and
sending the first RAT suspect indicator to a non-access stratum layer entity.

4. The method of claim 3, further comprising:
setting, based at least in part on scanning for RF energy, a RAT search continuity parameter to identify the second RAT for further searching of one or more additional RF bands associated with the second RAT if service is not acquired with respect to the first RAT based at least in part on the subsequent search; and
performing, based at least in part on the first RAT suspect indicator, the subsequent search for the first network.

5. The method of claim 3, further comprising:
setting, based at least in part on scanning for RF energy, a RAT search continuity parameter to identify a third RAT for further searching if service is not acquired with respect to the first RAT based at least in part on the subsequent search; and
performing, based at least in part on the first RAT suspect indicator, the subsequent search for the first network.

6. The method of claim 1, further comprising:
sending, when service is not acquired with respect to the first RAT, first network camped history information to a non-access stratum entity; and
determining, prior to identifying the RF spectrum overlap, that the first RF band associated with the first RAT is included in the first network camped history information.

7. The method of claim 1, further comprising:
setting, based at least in part on the identifying the RF spectrum overlap, an RF spectrum overlap indicator; and
sending, based at least in part on the RF spectrum overlap, network information associated with the first RAT to a radio resource entity associated with the second RAT.

8. The method of claim 7, further comprising:
sending network information associated with the first RAT comprises sending, by a non-access stratum layer entity, network information including the first RF band and at least one evolved universal terrestrial radio access (E-UTRA) absolute RF channel number (EARFCN) to the radio resource entity associated with the second RAT.

9. The method of claim 7, further comprising:
mapping, by the radio resource entity associated with the second RAT, the network information associated with the first RAT to the second RF band and at least one universal terrestrial radio access (UTRA) absolute RF channel number (UARFCN).

10. The method of claim 9, wherein
the scanning for RF energy corresponding to the second RF band comprises scanning, based at least in part on the mapping, for RF energy corresponding to the second RF band of the second RAT.

11. The method of claim 1, wherein
the RAT search cycle includes a sequential order of RATs to be searched that includes at least one of searching the first RAT during the first time period, searching the second RAT during the second time period, or searching a third RAT during a third time period.

12. The method of claim 11, wherein
the second RAT is different from the first RAT and the third RAT is different from the first RAT and the second RAT.

13. The method of claim 1, wherein
the subsequent search for the first network comprises a long term evolution (LTE) acquisition database scan.

14. The method of claim 1, further comprising:
acquiring service with respect to the first RAT based at least in part on the subsequent search, without searching for a third network associated with a third RAT during a third time period in the RAT search cycle.

15. An apparatus for wireless communication, in a system comprising:
a processor;
memory in electronic communication with the processor; and
one or more instructions stored in the memory and operable, when executed by the processor, to cause the apparatus to:
search for a first network associated with a first radio access technology (RAT) during a first time period in a RAT search cycle;
search, when service is not acquired with respect to the first RAT, for a second network associated with a second RAT during a second time period in the RAT search cycle;
identify a radio frequency (RF) spectrum overlap in which a first RF band associated with the first RAT overlaps with a second RF band associated with the second RAT;
scan, when service is not acquired with respect to the second RAT, for RF energy corresponding to the second RF band of the second RAT; and
determine, based at least in part on the scanning, whether to perform a subsequent search for the first network in the first RF band of the first RAT.

16. The apparatus of claim 15, wherein the one or more instructions are further executable by the processor to:
perform the subsequent search for the first network when the RF energy satisfies a threshold for operable communications associated with the first RAT.

17. The apparatus of claim 15, wherein the one or more instructions are further executable by the processor to:
set, based at least in part on scanning for RF energy, a first RAT suspect indicator; and
send the first RAT suspect indicator to a non-access stratum layer entity.

18. The apparatus of claim 17, wherein the one or more instructions are further executable by the processor to:
set, based at least in part on scanning for RF energy, a RAT search continuity parameter to identify the second RAT or a third RAT for further searching of one or more additional RF bands associated with the second RAT or the third RAT if service is not acquired with respect to the first RAT based at least in part on the subsequent search; and
perform, based at least in part on the first RAT suspect indicator, the subsequent search for the first network.

19. The apparatus of claim 15, wherein the one or more instructions are further executable by the processor to:
acquire service with respect to the first RAT based at least in part on the subsequent search, without searching for a third network associated with a third RAT during a third time period in the RAT search cycle.

20. A non-transitory computer readable medium storing code for wireless communication, the code comprising one or more instructions executable by a processor to:
search for a first network associated with a first radio access technology (RAT) during a first time period in a RAT search cycle;
search, when service is not acquired with respect to the first RAT, for a second network associated with a second RAT during a second time period in the RAT search cycle;
identify a radio frequency (RF) spectrum overlap in which a first RF band associated with the first RAT overlaps with a second RF band associated with the second RAT;
scan, when service is not acquired with respect to the second RAT, for RF energy corresponding to the second RF band of the second RAT; and
determine, based at least in part on the scanning, whether to perform a subsequent search for the first network in the first RF band of the first RAT.
